(19) United States
(12) Patent Application Publication
(10) Pub. No.: US 2019/0028817 A1
(43) Pub. Date: Jan. 24, 2019

(54) SYSTEM AND METHOD FOR A DIRECTIONAL SPEAKER SELECTION

(71) Applicant: WIZEDSP LTD., Tel-Aviv (IL)

(72) Inventor: OZ GABAI, TEL-AVIV (IL)

(21) Appl. No.: 16/039,542

(22) Filed: Jul. 19, 2018

Related U.S. Application Data
(60) Provisional application No. 62/535,135, filed on Jul. 20, 2017.

(51) Int. Cl. H04R 25/00; H04N 5/247; G06K 9/00

(52) U.S. Cl. CPC H04R 25/407; H04R 25/405; H04R 25/505; H04R 2225/41; G06K 9/00362; G06K 9/00335; H04N 5/247

(57) ABSTRACT

Performing sound selection by processing sound source separation on input received from microphones mounted in a wide sector around a device to create a plurality of first sound streams, each first sound stream associated with a source of sound; detecting at least one human image in imaging data acquired from at least one camera collecting imaging data from the wide sector; determining a first direction within the wide sector for at least one of the human images; forming an acoustic beam, the first direction, using a plurality of microphones, where the beam being directed at the first direction to produce a second sound stream; comparing the second sound stream with each of the first sound streams to form a plurality of comparison results; and associating a selected first sound stream with the human object according to a best-fit comparison result.

### CROSS-REFERENCE TO RELATED APPLICATIONS

This application claims the benefit of priority from U.S. Provisional Patent Application Ser. No. 62/535,135 filed Jul. 20, 2017, entitled “Directional hearing aid”, the disclosure of which is hereby incorporated by reference in its entirety.

### FIELD

The method and apparatus disclosed herein are related to the field of sound selection, and, more particularly, but not exclusively to systems and methods for focusing the acoustic amplification on a selected source of sound, and, more particularly, but not exclusively to systems and methods for focusing the acoustic amplification on a human speaker, and, more particularly, but not exclusively to a directional hearing aid.

### BACKGROUND

There are several devices that typically operate in a room with a plurality of sound sources, and need to focus on a particular source of sound. For example, hearing aid devices and smart speakers. Both these devices need to focus on a particular speaker.

In a room there may be several sources of sound of the same type such as speech. Additionally, due to reflections from walls and other reflective objects, the same sound may appear from several directions. Or, otherwise put, several different sounds may be received from the same direction, though their origin may be in different direction. The term focus here means that the sound received from the particular selected source should be amplified and the other sounds should be filtered out.

There are several technologies using a plurality of microphones to focus on a particular source of sound such as beamforming and blind (audio) source separation (BSS or BASS). Beamforming is inefficient if, for example due to reflections, several different sounds are received from the same direction. BASS enables sound separation but is not directional.

Ear-mounted hearing aids are known. Also known are hearing aid systems, which include an external unit that communicates with an ear-mounted unit. Wireless accessories for hearing aids are described by ReSound (www.resound.com) and Phonak (www.phonak.com), for example. Within such systems, the larger size of an external unit compared with an ear-mounted unit allows the inclusion of better quality microphones, larger batteries and more efficient and easily usable charging options. In particular, an external unit allows the inclusion of an array of microphones with a beamforming functionality, thereby to extract the sound coming from one or more speakers, especially in an ambient noise environment.

Hearing aid systems utilizing an image sensing functionality are also known. U.S. Pat. No. 9,491,553 (titled “Method of audio signal processing and hearing aid system for implementing the same”) describes a hearing aid system, wherein images captured by a camera facilitate the beamforming operation of a microphone array. In a typical embodiment, a camera, an array of microphones and two ear-plugged speakers are mounted on a suitable eyeglass frame, with the camera placed in a front-facing position in the middle of the eyeglass frame and the microphones spread along the frame facing the front and both sides of the user. This arrangement allows the system to bring into account not only the presence of a human figure in the user's vicinity but also the position of a figure with respect to the direction in which the user is looking.

Another hearing aid system mounted on an eyeglass frame is described by U.S. Pat. No. 6,707,921 (titled “Use of mouth position and mouth movement to filter noise from speech in a hearing aid”). In addition to a front-facing camera, this patent also describes the inclusion of an eye scanner on the inner side of an eyeglass frame, allowing the detection of the user's direction of looking.

Focusing the microphone array on the speaker is a powerful tool, however, focusing the microphone array in the current direction of eye-sight may prevent the listener from diverting his visual attention from the speaker, as is most common.

It would therefore be highly advantageous to have devoid of the above limitations and/or disadvantages.

### SUMMARY

According to one exemplary embodiment there is provided a method, a device, and a computer program including a plurality of microphones mounted in at least a wide sector around the device, a at least one camera mounted on the device to collect imaging data from the at least wide sector around the device, a processor operative to: process sound source separation on sound input received from the plurality of microphones to create a plurality of first sound streams, each first sound stream associated with a source of sound, detect in the imaging data at least one image of a first human object, determine a first direction within the at least wide sector for at least one of the first human objects, for at least one of the first directions, form an acoustic beam, using the plurality of microphones, the acoustic beam being directed at the first direction to produce a second sound stream, compare the second sound stream with each of the first sound streams to form a plurality of comparison results, and associate a selected first sound stream with the human object according to a best-fit comparison result.

According to another exemplary embodiment there is additionally provided a communicating interface, where the processor additionally operative to communicate a selected first sound stream, via the communication interface, to at least one of a user and an external device.

According to still another exemplary embodiment the processor is additionally operative to: acquire a second imaging data from the at least one camera, detect in the second imaging data an image of a head of a second human object, detect a direction of orientation of the head of the second human object with respect to the at least wide sector, determine a selected first human object closest to the direction of orientation of the head of the second human object, and select a first sound stream of the plurality of first sound streams associate with the selected first human object.

According to yet another exemplary embodiment there is additionally provided a second camera mounted on a the device pointed in a second direction different than the at least wide sector to collect second imaging data from the second direction, where the second camera providing acquiring the second imaging data.

Further according to another exemplary embodiment the processor is additionally operative to: detect lip motion for at least one first human object, and determine the first direction according to the first human object for whom lip motion is detected.

Still further according to another exemplary embodiment there is provided a method, a device, and a computer program including: a plurality of microphones mounted on a first side of the hearing-aid device, a first camera mounted on the first side of the hearing-aid device, a second camera mounted on a second side of the hearing-aid device, a processor operative to: detect, in imaging data provided by the second camera, a direction of orientation of a head of a first user, detect, in imaging data provided by the first camera, within the direction of the head of the first user, a second user talking, form an acoustic beam, using the plurality of microphones, the acoustic beam being directed at the second user, and collect acoustic signal via the acoustic beam.

Yet further according to another exemplary embodiment the second side is substantially in the opposite side of the first side.

Even further according to another exemplary embodiment the imaging data provided by the first camera within the direction of the head of the first user, includes a sector of a predefined angle around the direction of the head of the first user.

Additionally according to another exemplary embodiment a communication interface is provided communicatively coupling the processor to an ear-mounted unit, where the processor is additionally operative to provide the acoustic signal to the ear-mounted unit.

According to yet another exemplary embodiment an ear-mounted unit includes an accelerometer operative to measure motion of the head of the first user to from head motion measurement, and the processor is additionally operative to detect, in imaging provided by the second camera, a direction of a head of a first user, according to the head motion measurement.

Unless otherwise defined, all technical and scientific terms used herein have the same meaning as commonly understood by one of ordinary skill in the relevant art. The materials, methods, and examples provided herein are illustrative only and not intended to be limiting. Except to the extent necessary or inherent in the processes themselves, no particular order to steps or stages of methods and processes described in this disclosure, including the figures, is intended or implied. In many cases the order of process steps may vary without changing the purpose or effect of the methods described.

### BRIEF DESCRIPTION OF THE DRAWINGS

Various embodiments are described herein, by way of example only, with reference to the accompanying drawings. With specific reference now to the drawings in detail, it is stressed that the particulars shown are by way of example and for purposes of illustrative discussion of the various embodiments only, and are presented in order to provide what is believed to be the most useful and readily understood description of the principles and conceptual aspects of the embodiment. In this regard, no attempt is made to show structural details of the embodiments in more detail than is necessary for a fundamental understanding of the subject matter, the description taken with the drawings making apparent to those skilled in the art how the several forms and structures may be embodied in practice.

In the drawings:

FIG. 1 is a simplified schematic illustration of a directional hearing aid apparatus;

FIG. 2 is a simplified schematic illustration of a wearable directional hearing aid apparatus;

FIG. 3 is a simplified schematic illustration of a directional hearing aid apparatus with accelerometer;

FIG. 4 is a simplified flowchart illustration of a beamforming setting procedure;

FIG. 5 is a simplified flowchart illustration of a beamforming alteration procedure;

FIG. 6 is a simplified flowchart illustration of a beamforming locking procedure;

FIG. 7 is a simplified flowchart illustration of a beamforming unlocking procedure;

FIG. 8 is a simplified flowchart illustration of a locking mode access procedure;

FIG. 9 is a simplified flowchart illustration of a side-lobe reduction setting procedure;

FIG. 10 is an isometric illustration of a directional hearing aid apparatus;

FIG. 11 is a top-view section of a directional hearing aid apparatus;

FIG. 12 is a simplified schematic illustration of an eyeglass holder directional hearing aid apparatus;

FIG. 13A is a simplified perspective illustration of a smart speaker device;

FIG. 13B is a simplified top view illustration of the smart speaker device;

FIG. 14 is a simplified electric schematic of a computing device useful for a smart speaker device and/or a hearing device; and

FIG. 15 is a simplified flow chart of a software program for processing sound source selection.

### DETAILED DESCRIPTION

The invention in embodiments thereof includes systems and methods for sound selection. Particularly, but not exclusively, the invention in embodiments thereof includes systems and methods for focusing the acoustic filtering and/or amplification on a selected source of sound. More particularly, but not exclusively, the invention in embodiments thereof includes systems and methods for focusing the acoustic filtering and/or amplification on a human speaker. More particularly, but not exclusively, the invention in embodiments thereof includes systems and methods for a directional hearing aid and/or smart speaker, and/or a similar device operating in a room. The principles and operation of the devices and methods according to the several exemplary embodiments presented herein may be better understood with reference to the following drawings and accompanying description.

Before explaining at least one embodiment in detail, it is to be understood that the embodiments are not limited in its application to the details of construction and the arrangement of the components set forth in the following description or illustrated in the drawings. Other embodiments may be practiced or carried out in various ways. Also, it is to be understood that the phraseology and terminology employed herein is for the purpose of description and should not be regarded as limiting.

In this document, an element of a drawing that is not described within the scope of the drawing and is labeled with a numeral that has been described in a previous drawing has the same use and description as in the previous drawings. Similarly, an element that is identified in the text by a numeral that does not appear in the drawing described by the text, has the same use and description as in the previous drawings where it was described.

The drawings in this document may not be to any scale. Different Figs. may use different scales and different scales can be used even within the same drawing, for example different scales for different views of the same object or different scales for the two adjacent objects.

The purpose of the embodiments herein is to focus on a particular source of sound such as a particular speaker, for example, in a room with multiple sources of sounds, including sound reflections.

The term ‘focus’ and/or ‘sound selection’ and/or ‘speaker selection’ may refer to any technology that can separate one source of sound from other sources of sounds such as filtering, selective amplification, beamforming, blind (audio) source separation (BSS or BASS), etc. There are several technologies using a plurality of microphones to focus on a particular source of sound such as beamforming and BASS.

Beamforming typically uses a plurality of microphones as an array of microphones to produce a directional acoustic beam. The beam is directed at a selected direction and sounds arriving from the selected direction are amplified while sounds arriving from other directions may be decreased. Beamforming has at least two major problems. One problems is side lobes that may amplify unwanted sounds. The other problem is reflections.

In a room with reflective objects such as walls a sound originated from one direction may be reflected from other directions. Therefore, several different sounds (originated in different places in the room, may be received from the same direction (as reflections).

The term ‘sound source separation’ may refer to any technology, such as blind (audio) source separation (BSS or BASS) that can receive an input audio stream and separate the received audio stream into two or more output audio streams, where each output audio stream is associated with a particular source of sound. Therefore, BASS may be focused on a particular sound type, but it is difficult to associate the particular sound with a particular physical source.

The purpose of the embodiments herein is to combine several object detection and sound selection technologies to focus on a selected physical source of sound such as a particular speaker. In this respect, the term ‘sound selection’ may refer to beamforming, and or blind (audio) source separation (BSS or BASS), and/or any other similar sound separation technology, and any combination thereof. Particularly, the terms ‘speech detection’ and/or ‘speech isolation’ may refer to a combination of ‘sound selection’ and ‘object detection’ technologies. The term ‘object detection’ may refer, for example, to image object detection using imaging data provided by one or more cameras.

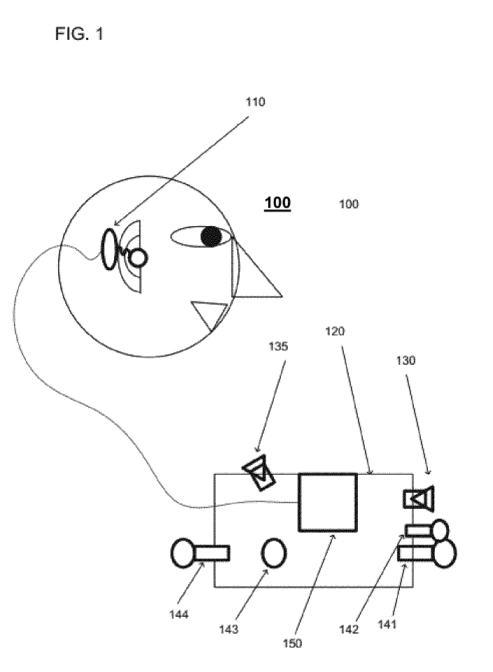

Reference is now made to FIG. 1, which is a simplified schematic illustration of a directional hearing aid apparatus in accordance with one embodiment of the present invention.

The purpose of the directional hearing aid of FIG. 1 is to provide a user with a selected sound emitted by and/or received from a selected human speaker, by combining object detection and sound selection. For example, by using image object detection and beamforming. However, any other technology or combination of technologies for object detection, and any other technology (e.g. BASS) or combination of technologies for sound selection, are contemplated.

Turning to FIG. 1, it is seen that a directional hearing aid apparatus 100 may include an ear-mounted unit 110 communicatively coupled to an external unit 120. Ear-mounted unit 110 is typically inserted into the user's ear, or is worn covering the ear, etc. The communication between ear-mounted unit 110 and external unit 120 may be wired using a communication cable or wireless.

Ear-mounted unit 110 may include a communication interface communicatively coupled to external unit 120, an amplifier, and a speaker. Ear-mounted unit 110 may also include a processor typically coupled to the communication interface, a memory typically coupled to the processor, and a digital-to-analog converter typically coupled to the processor and to the amplifier. Ear-mounted unit 110 may also include one or more microphones to operate as a standalone hearing aid device. Ear-mounted unit 110 may also include a battery or a similar power source, for example, if the communication between ear-mounted unit R110 and external unit 120 is wireless, and/or when operating as a standalone hearing aid device.

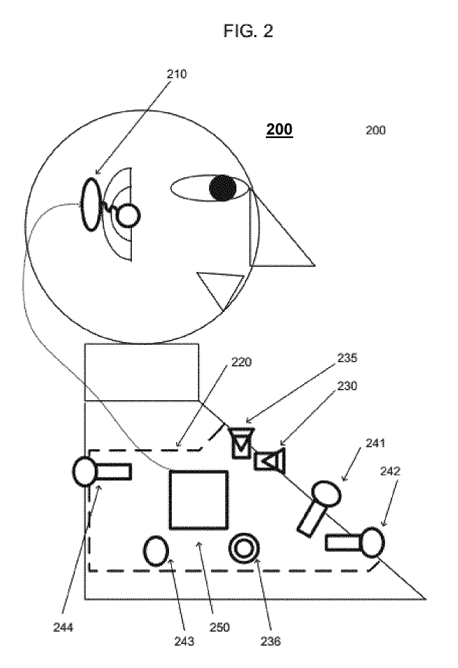

External unit 120 may be carried by the user, and/or worn by the user, and/or placed on a table in front of the user. For example, external unit 120 may be worn by the user such as hanging from the user's neck, and/or mounted on the user's collar as described below with reference to FIG. 2.

External unit 120 may include two or more cameras typically arranged in the perimeter of external unit 120, where the two or more cameras are pointing in different directions. For example, as shown in FIG. 1, for example, a first camera 130 is preferably front-facing and operative to capture images of one or more persons in front of the user, preferably providing a wide angle frame. A second camera 135 is preferably upward-facing and/or backwards-facing and is operative to capture images of the user's own head and/or motion thereof. Preferably, external unit 120 also comprises one or more cameras facing backwards and/or to the sides and allowing the capture of images of persons in different directions from the user.

Hence, the term ‘first camera’ may refer to one or more cameras, such as camera 135, typically mounted on a first side of the external unit 120, typically directed away from the user, to capture imaging data in front of the user, which imaging data may include people talking. The term ‘second camera’ may refer to one or more cameras such as camera. 135, typically mounted on a second side of the external unit 120, which may be typically directed at the user, to capture imaging data which may include the head of the user. The plurality of ‘first camera’ as well as the plurality of ‘second camera’, may be distributed, respectively, to provide a wide angle view of respective imaging data.

External unit 120 may also include a plurality of microphones, such as microphones 141, 142, 143 and 144, that may form an array of microphones, allowing the capture of sound from one or more directions in the user's environment. As shown in FIG. 1, for example, microphones 141 and 142 are front-facing and are operative to receive voice coming from the direction that the user is facing, such as the second side as described above. As shown in FIG. 1, for example, microphone 143 may face the direction to the user's right hand side, and a similar microphone, not shown in FIG. 1, may face the direction to the user's left hand side. As shown in FIG. 1, for example, microphone 144 may face the user and/or the second side of external unit 120 as described above, to capture voices coming from behind the user and/or the user's own voice.

External unit 120 may also include a central control unit 150, or a central processing unit (CPU) and may also include a wireless communication module (not shown in FIG. 1) operative to communicate with ear-mounted unit 110. Central control unit 150 may receive input data from cameras 130 and 135 (e.g., imaging data) and from microphones 141-144 (e.g., sound and/or audio data). Central control unit 150 may include memory and/or storage device, which may include software program as well as data. Central control unit 150 may be operative to execute instructions of the software program, typically to process the data.

Typically, the CPU or central control unit 150, and/or the software program included in and/or executed by the CPU, is operative to process the imaging data received from one or more of the cameras to detect one or more images of human objects within the imaging data.

The CPU or central control unit 150, and/or the software program included in and/or executed by the CPU, may also be operative to detect the head of the human object (user), as well as the detecting the orientation of the head of the human object, such as the direction in which the human object is looking. The terms ‘direction of the head’ or head direction' may refer to the orientation of the head of the human object.

The CPU or central control unit 150, and/or the software program included in and/or executed by the CPU, may also be operative to detect lip motion, or a similar imaging data, within the imaging data of a particular human object, to determine that the particular human is talking.

The CPU or central control unit 150, and/or the software program included in and/or executed by the CPU, may also be operative to detect a human voice received via any of the microphones, and further to detect a direction from which the human voice is received. Typically, The CPU or central control unit 150, and/or the software program included in and/or executed by the CPU, may also be operative to detect voice direction by comparing at least one of amplitude of voice received by two or more microphones, and/or time of arrival of voice received by two or more microphones, for example by operative a plurality of microphone as a phased array of microphones.

Thus, based on these inputs, central control unit 150 may be operative to determine the direction from which comes the voice that the user is most likely to be interested in hearing. Central control unit 150 may then set beamforming of any number of microphones 141-144. Thereby extracting the targeted voice, and filtering out ambient noise. Central control unit 150 may then communicate the voice as a suitable audio signal to ear-mounted unit 110, thereby to be sounded to the user via an ear-plugged speaker.

The term ‘beamforming’ may refer to operations using two or more microphones, and particularly an array of microphones, to form an acoustic beam directed towards a selected direction and/or a source of sound. For example, to increase the quality of a particular signal received by the microphones from the selected direction. For example, by increase the amplitude of the selected signal and/or reducing the amplitude of unwanted signals.

However, with respect to the directional hearing aid apparatus 100, beamforming may be augmented by BASS, and/or vice versa, for example as part of a process of sound selection, as will be further described below.

By way of example, the operation of directional hearing aid apparatus 100 is as follows: A first user carrying directional hearing aid apparatus 100 enters a restaurant and places external unit 120 on a table in front of the user. One or more people (second users) may be sitting facing the first user at a variety of angles. External unit 120 detects a person (one of the second users) in a first given direction in front of the user, preferably also detecting lip motion by this person. Then, if external unit 120 also detects human voice from this first direction, external unit 120 may set the beamforming to extract the voice and filter out other voices. When external unit 120 detects head motion by the first user towards a second direction, external unit 120 may search for a person (another one of the second users) in this second direction. External unit 120 may further search and/or detect lip motion for this person. External unit 120 may also search for human voice from this second direction.

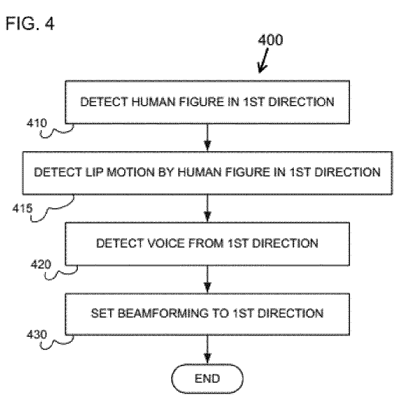

As long as there is no detection of a person and/or voice in this second direction (where the first user is looking), external unit 120 retains the beamforming in the first direction. This allows the user to look around freely while listening to the same person. This and other operations of a directional hearing aid apparatus are described in greater detail below with reference to FIGS. 4-9.

Reference is now made to FIG. 2, which is a simplified schematic illustration of a wearable directional hearing aid apparatus in accordance with an embodiment of the present invention. As an option, the illustration of FIG. 2 may be viewed in the context of the details of the previous Figures. Of course, however, the illustration of FIG. 2 may be viewed in the context of any desired environment. Further, the aforementioned definitions may equally apply to the description below.

The purpose of the hearing aid of FIG. 2 is to provide a user with a selected sound emitted by and/or received from a selected human speaker, by combining object detection and sound selection. For example, by using image object detection and beamforming. However, any other technology or combination of technologies for object detection, and any other technology (e.g. BASS) or combination of technologies for sound selection, are contemplated.

Turning to FIG. 2, it is seen that a wearable directional hearing aid apparatus 200 may include an ear-mounted unit 210 and a wearable external unit 220. As shown in FIG. 2, external unit 220 may be collar-mounted or otherwise worn from the neck.

Ear-mounted unit 210 may include a suitable speaker, which may be plugged into the user's ear. Preferably, ear-mounted unit 210 may also include one or more suitable microphones to enable operation as a standalone hearing aid device (e.g., without using wearable external unit 220).

Wearable external unit 220 may be at least partially similar to external unit 120 described above with reference to FIG. 1. Wearable external unit 220 may include two similar parts which are respectively attached to two sides of a user's collar and are operative to be tied together, thereby to function as a single unit. For example each part of unit 220 is attached to one side of the collar by a suitable clip, and then the two parts are tied together behind the user's neck, thereby to be both physically and electrically connected. FIG. 2 shows the user from one side and hence only one of the two parts of wearable external unit 220 is shown, while the second part is at the other side, hidden by the user and the first part. Wearable external unit 220 by be also termed herein collar-mounted unit 220. However, wearable external unit 220 may be attached to the user in any other manner.

Collar-mounted unit 220 preferably includes six or more cameras including: Two front-facing cameras 230, typically one on each side of collar-mounted unit 220. Cameras 230 may be operative to capture images of one or more persons in a preferably wide angle in front of the user.

Two upward-facing cameras 235, typically one on each side of collar-mounted unit 220, are operative to capture images of the user's head, and/or chin, and/or beard, thereby to allow detection of the direction in which the user's head is turned.

Two side-facing cameras 236, typically one on each side of collar-mounted unit 220, are operative to capture images of one or more persons in a preferably wide angle to the side of the user.

It is therefore appreciated that for any direction in which the user turns the user's head, there is at least one camera that captures what is in front of the user; at least one camera that captures what the user is looking at, and at least one camera that captures the user's head, allowing to determine the direction in which the user's head is turned.

Collar-mounted unit 220 comprises a plurality of microphones, such as microphones 241, 242, 243, and 244 as shown in FIG. 2, as well as a fifth microphone at the other, hidden side of the user, corresponding to side microphone 243. These five microphones may form an array of microphones allowing the capture of sound from one or more directions in the user's environment.

In the current example, collar-mounted unit 220 comprises five microphones including microphone 241, which is upwards-facing and is preferably operative to capture the user's own voice. One or more microphones 242, which are front-facing and are operative to receive voice coming from the direction that the user is facing. A microphone 243 that faces the direction to the user's right hand side; a microphone, not shown in FIG. 2, that faces the direction to the user's left hand side; and a microphone 244 that faces backwards from unit 220, and is operative to capture voices coming from behind the user. Front-facing microphone 242 may also be operative to capture the user's own voice.

Collar-mounted unit 220 may also include a central control unit 250, typically including a suitable CPU (central processing unit), memory and or storage for storing software program and/or data, and a preferably wireless communication module that is operative to communicate with ear-mounted unit 210.

As described above with reference to external unit 120, central control unit 250 may receive input from the cameras and/or microphones. The CPU, and/or the central control unit 250, and/or the software program may use images received via any of the cameras to detect images of human objects, detect the head of such human objects, and detect lip motion of such human objects.

The CPU, and/or the central control unit 250, and/or the software program may be operative to detect human voices received via the microphones. The CPU may be operative to detect the direction in which the user is looking based in input via camera 235. Thus based on the inputs, central control unit 250 is operative to determine the direction from which comes the voice that the user is most likely to be interested in hearing. The CPU is then operative to set the beamforming for microphone array, thereby to extract the voice and to filter out ambient noise. Central control unit 250 may then communicate the voice as a suitable audio signal to ear-mounted unit 210, thereby to be sounded to the user via an ear-plugged speaker.

With respect to the wearable directional hearing aid apparatus 200, beamforming may be augmented by BASS, and/or vice versa, for example as part of a process of sound selection, as will be further described below.

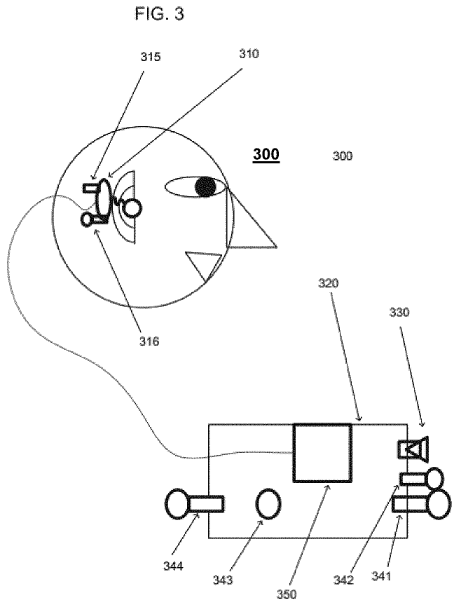

Reference is now made to FIG. 3, which is a simplified schematic illustration of a directional hearing aid apparatus in accordance with another embodiment. As an option, the illustration of the directional hearing aid of FIG. 3 may be viewed in the context of the details of the previous Figures. Of course, however, the illustration of the directional hearing aid of FIG. 3 may be viewed in the context of any desired environment. Further, the aforementioned definitions may equally apply to the description below.

The purpose of the hearing aid of FIG. 3 is to provide a user with a selected sound emitted by and/or received from a selected human speaker, by combining object detection and sound selection. For example, by using image object detection and beamforming. However, any other technology or combination of technologies for object detection, and any other technology (e.g. BASS) or combination of technologies for sound selection, are contemplated.

As shown in FIG. 3, a directional hearing aid apparatus 300 may include an ear-mounted unit 310 and an external unit 320. Ear-mounted unit 310 may include a speaker which may be plugged into a user's ear. Ear-mounted unit 310 may also include an accelerometer 315 that is operative to track the motion of the user's head. Ear-mounted unit 310 may further include a microphone 316 to allow ear-mounted unit 310 to operate as a standalone hearing aid device.

External unit 320 may be at least partially similar to external unit 120 described above with reference to FIG. 1. External unit 320 may be suitable for placement on a table in front of the user wearing ear-mounted unit 310.

Alternately or in addition, external unit 320 may be mounted on the user wearing ear-mounted unit 310, for example by being hanged on the user's neck, or mounted on the user's collar, as described above with reference to FIG. 2, and/or by any other suitable means.

External unit 320 may also include one or more cameras 330 that may be front-facing, namely oriented away from the user, to capture images of one or more persons (human objects) in front of the user wearing ear-mounted unit 310. The one or more cameras 330 may provide a wide angle frame, or view, of the area in front of the user. External unit 320 may also include one or more cameras facing backwards, and/or to the sides, and allowing the capture of images of persons in various directions from the user.

External unit 320 may also include a plurality of microphones 341-344 that may form an array of microphones allowing the capture of sound from one or more directions in the user's environment. In the current example, unit 320 includes 5 microphones. In the example shown in FIG. 3, microphones 341 and 342 are front-facing and are operative to receive voice coming from the direction that the user is facing. Microphone 343 is directed to the user's right hand-side. A microphone not shown in FIG. 3 faces is directed to the user's left hand-side. And a microphone 344 may be facing backwards from unit 320, namely towards the user, to capture voices coming from behind the user and/or the user's own voice.

The array of microphones 341-344 may function as a unified microphone array to provide beamforming functionality. The array of microphones 341-344 may function together with microphone 316 on ear-mounted unit 310 to provide enhanced beamforming. With respect to the directional hearing aid apparatus 300, beamforming may be augmented by BASS, and/or vice versa, for example as part of a process of sound selection, as will be further described below.

It is assumed that the user wearing ear-mounted unit 310 intuitively and/or automatically turns his or hers head so that microphone 316 is pointed at the direction of the source of the sound of interest. Thereafter, external unit 320 may use the array of microphones 341-344 to form a beam directed in the direction in which that microphone 316 is pointing. Thereafter, external unit 320 may use the array of microphones 341-344 together with microphone 316 to form a combined beam directed towards the source of the sound of interest to the user.

External unit 320 may also include a central control unit 350, including a central processing unit (CPU) and a wireless communication module operative to communicate with ear-mounted unit 310. Central control unit 350 may receive inputs from camera 330 and from microphones 341-344 and preferably also from accelerometer 315, whose reading is typically communicated by ear-mounted unit 310 to central control unit 350 via the wireless communication unit.

Central control unit 350 or its CPU may process imaging data received from one or more cameras 330 to detect one or more persons, and may also detect lip motion of any of such person

Central control unit 350 or its CPU may process sound data received from one or more microphones to detect human voices.

Central control unit 350 or its CPU may process sound data and imaging data to associate particular speech with particular human objects (persons) and particularly with lip motion.

At a third level, Central control unit 350 or its CPU may detect the direction in which the user directs the user head (e.g., where the user is looking) based in input data received from accelerometer 315. Thus based on these inputs, central control unit 350 may determine the direction of the voice of interest to the user. Central control unit 350 is then operative to set the beamforming for microphones 341-344, thereby to extract the voice and to filter out ambient noise.

Central control unit 350 may then communicate the voice as a suitable audio signal to ear-mounted unit 310, thereby to be sounded to the user via an ear-plugged speaker.

Reference is now made to FIG. 4, which is a simplified flowchart of a beamforming setting procedure 400, provided and employed in accordance with an embodiment. As an option, the flowchart of a beamforming setting procedure 400 of FIG. 4 may be viewed in the context of the details of the previous Figures. Of course, however, the flowchart of a beamforming setting procedure 400 of FIG. 4 may be viewed in the context of any desired environment. Further, the aforementioned definitions may equally apply to the description below.

Beamforming setting procedure 400 may be implemented as a software program executed by a directional hearing aid apparatus similar to any of the devices described above with reference to FIGS. 1 to 3. Particularly by a controller or CPU operative to execute instructions of the software program implementing beamforming setting procedure 400. For example, the CPU of central control unit 150 described above with reference to FIG. 1. However, beamforming setting procedure 400 may be operated by any CPU of any device such as external unit 220 of FIG. 2, and/or external unit 320 of FIG. 3. Directional hearing aid apparatus 100 is used herein by way of a non-limiting example.

In a typical scenario, a user carrying apparatus 100 of FIG. 1 sits in place full of ambient noise such as a restaurant, for example. The user places external unit 120 of apparatus 100 on a table in front of the user. Apparatus 100 then detects a human figure in front of the user based on one or more images captured via camera 130.

The term ‘beamforming setting’ may refer to determining a set of parameters associated with forming the acoustic beam of two or more microphones as described above. Such parameters may include signal amplification parameter(s), signal phasing parameter(s), signal value reversal, etc., for each of the microphones for which the acoustic beam is formed. The purpose of a particular ‘beamforming setting’ is to direct the acoustic beam in a selectable direction.

As seen in FIG. 4, beamforming setting procedure 400 may start with step 410 by detecting a human figure (person) in imaging data received from a camera directed towards a first direction.

Beamforming setting procedure 400 may then proceed to step 415 to detect kip motion if one or more human figures detected in step 410. For example, apparatus 100 detects lip motion by a human figure in front of the user based on a stream of images captured via camera 130.

Beamforming setting procedure 400 may then proceed to step 420 to detect a human voice from the first direction. For example, Beamforming setting procedure 400 (e.g. apparatus 100) may use input received via the array of microphones 141-144, thereby to detect the human voice coming from the first direction.

Beamforming setting procedure 400 may then proceed to step 430 to set the beamforming to the first direction. Setting the beam-form is preferably based on the detection of the human figure, the lip motion associated with the human figure, and the human voice from the same first direction. Beamforming enables directional hearing aid apparatus 100 to extract the voice signal of interest from the first direction and filter out ambient noise. Beamforming setting procedure 400 may be augmented by BASS, and/or vice versa, for example as part of a process of sound selection, as will be further described below.

It is appreciated that the beamforming setting procedure of FIG. 4 is only an example, and that the directional hearing aid apparatus described with reference to FIG. 1-3 are also operative to set beamforming in other ways. For example, the apparatus initially detects a human voice coming from a first direction, and then checks for the presence of a human figure in the same direction. Beamforming is then set to the direction only if a human figure is detected in the direction within a given distance from the user, for example in a distance smaller than 2 meters.

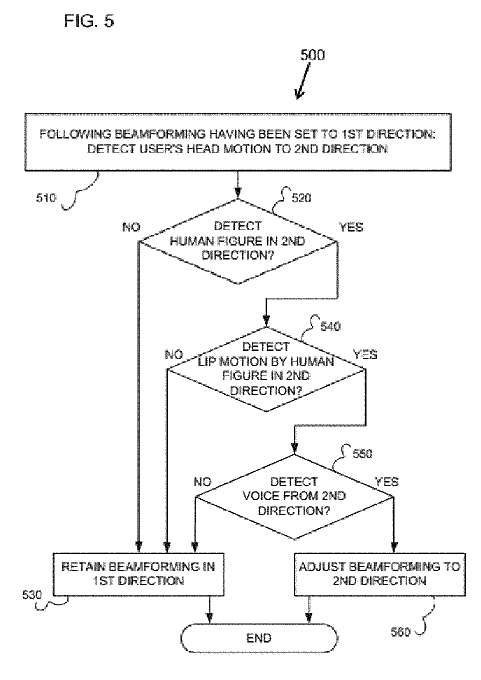

Reference is now made to FIG. 5, which is a simplified flowchart of a beamforming alteration procedure 500, provided and employed in accordance with one embodiment. As an option, the flowchart of a beamforming alteration procedure 500 of FIG. 5 may be viewed in the context of the details of the previous Figures. Of course, however, the flowchart of a beamforming alteration procedure 500 of FIG. 5 may be viewed in the context of any desired environment. Further, the aforementioned definitions may equally apply to the description below.

Beamforming alteration procedure 500 may be performed by a directional hearing aid apparatus such as any of the devices described above with reference to FIGS. 1 to 3. Particularly by a controller or CPU operative to execute instructions of a software program implementing beamforming alteration procedure 500. Such processor may be similar to central control unit 150 described above with reference to FIG. 1. However, a software program implementing beamforming alteration procedure 500 may be executed by any other devices, such as external unit 220 of FIG. 2, and/or external unit 320 of FIG. 3. Directional hearing aid apparatus 100 is used herein by way of a non-limiting example.

The term ‘beamforming alteration’ may refer to determining that the current beamforming setting should be changed, and/or replaced, by a new beamforming setting. For example, to determine that the set of parameters associated the current acoustic beam should be changed to direct the acoustic beam in a different direction.

A shown in FIG. 5, beamforming alteration procedure 500 may be executed following the setting of the beam to a first direction (direction of reference) as described with reference to FIG. 4. Beamforming alteration procedure 500 may then start with step 510 by detecting head motion of the user using the hearing aid device. That is, for example, the user using ear-mounted unit 110.

This head motion may be detected, for example, using camera 135 as shown and described with reference to FIG. 1, and/or using upward-facing cameras 235 of collar-mounted unit 220 as shown and described with reference to FIG. 2, and/or accelerometer 315 of ear-mounted unit 310 as shown and described with reference to FIG. 3.

Step 510 eventually determines that the head of the user is directed in a second direction. For example, apparatus 100 of FIG. 1 detects a motion of the user's head via one or more images captured via camera 135. Detecting a motion of the user's chin, apparatus 100 is then operative to determine the direction to which the user has turned the user's sight.

Beamforming alteration procedure 500 may then proceed to step 520 to detect a human figure in the second direction. For example, in apparatus 100 of FIG. 1, the second direction is covered by a wide-angle front-facing camera 130, allowing apparatus 100 to determine the presence of a human figure in the second direction based on images captured via camera 130.

The directional hearing aid apparatus may include one or more side-facing cameras, allowing the apparatus to detect the presence of a human figure in case the second direction cannot be covered by a front-facing camera. Preferably, if the second direction is not covered by a camera on the directional hearing aid apparatus, then step 520 may be skipped, and the procedure continues to step 550.

If in step 520 no human figure is detected, then beamforming alteration procedure 500 may then proceed to step 530 to retain the current beamforming setting (e.g., where the beam is pointed in the first direction) and the procedure is thereby terminated.

If step 520 detects a human figure in the second direction, then beamforming alteration procedure 500 may proceed to step 540 to detect lip motion of the human figure detected in the second direction.

As discussed above with reference to FIGS. 1, 2 and 3, a directional hearing aid device, and particularly the external unit such as units 120, 220 and 320, may include one or more side-facing cameras allowing the hearing aid device to detect lip motion by the human figure if the second direction cannot be covered by a front-facing camera. For example, in apparatus 100 of FIG. 1, the second direction is covered by a wide-angle front-facing camera 130, allowing apparatus 100 to detect lip motion of the human figure in the second direction based on images captured via camera 130.

If step 540 does not detect lip motion of the human figure in the second direction, then, beamforming alteration procedure 500 may proceed to step 530 to retain the current beamforming setting in the first direction, and the procedure is thereby terminated.

If step 540 detects lip motion of the human figure in the second direction, then beamforming alteration procedure 500 may proceed to step 550 to detect a human voice coming from the second direction. For example, hearing aid 100 may use input signal received via an array of microphones 141-144 to detect human voice coming from the second direction.

If step 550 does not detect human voice in the second direction, then beamforming alteration procedure 500 may proceed to step 530 to retain the beamforming setting in the first direction, and the procedure is thereby terminated.

If step 550 detects human voice in the second direction, then beamforming alteration procedure 500 may proceed to step 560, to alter the beamforming setting, typically by directing the beam towards the second direction, and the second direction now becomes the direction of reference (first direction). Beamforming alteration procedure 500 may then terminated. Step 560 may be implemented, for example, using beamforming setting procedure 400 of FIG. 4.

The beamforming alteration procedure 500 may therefore be restarted upon detection of a motion of the user's head in a direction different from the first and/or second direction.

It is appreciated that beamforming alteration procedure 500 is particularly advantageous as it allows a hearing aid user to listen to an interlocutor in an ambient noise environment while also allowing the user to freely turn the user's sight in any direction. The hearing aid apparatus may keep the beamforming setting in the direction of the same interlocutor as long as the user is casually looking around. Beamforming alteration may take place only if the user's sight turns in a direction wherein both a human figure and human voice are detected.

It is appreciated that beamforming alteration procedure 500, as well as steps 530 and 560, may be augmented by BASS, and/or vice versa, for example as part of a process of sound selection, as will be further described below.

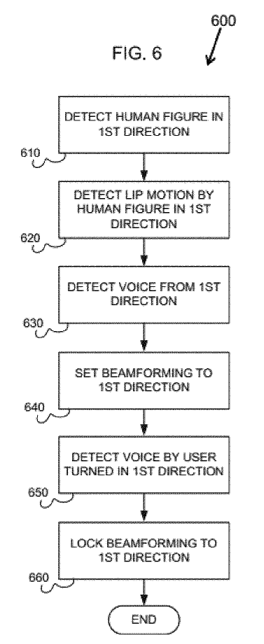

Reference is now made to FIG. 6, which is a simplified flowchart of a beamforming locking procedure 600 provided and employed in accordance with one embodiment of the present invention. As an option, the beamforming locking procedure 600 of FIG. 6 may be viewed in the context of the details of the previous Figures. Of course, however, the beamforming locking procedure 600 of FIG. 6 may be viewed in the context of any desired environment. Further, the aforementioned definitions may equally apply to the description below.

Beamforming locking procedure 600 may be implemented as a software program executed by a directional hearing aid device, and particularly by a controller or processors of the external unit of a hearing aid device. For example, such hearing aid device may be similar to the hearing aid devices described above with reference to FIGS. 1, 2 and/or 3. Typically, a central processor is executing the beamforming locking procedure 600 may be similar to the processor or central control unit 150 described above with reference to FIG. 1. However, beamforming locking procedure 600 may be operated by any CPU of any device such as external unit 220 of FIG. 2, and/or external unit 320 of FIG. 3. Directional hearing aid apparatus 100 is used herein by way of a non-limiting example.

As shown in FIG. 6 beamforming locking procedure 600 may start with step 610 by detecting a human figure in a first direction. For example, a user carrying apparatus 100 of FIG. 1 sits in place full of ambient noise, such as a restaurant. The user places external unit 120 of apparatus 100 on a table in front of the user. Apparatus 100 then detects a human figure in front of the user based on one or more images captured via camera 130.

Beamforming locking procedure 600 may then proceed to step 620, to detect lip motion by the human figure detected in the first direction in step 610. For example, apparatus 100 is operative to detect lip motion by the human figure in front of the user based on one or more images captured via camera 130.

Beamforming locking procedure 600 may then proceed to step 630 to detect human voice from the first direction. For example, apparatus 100 utilizes input received via an array of microphones 141-144, thereby to detect of human voice coming from the direction.

Following the detection of a human figure, preferably with lip motion detection, and preferably with human voice from the same first direction, beamforming locking procedure 600 may proceed to step 640 to set the beamforming to the first direction. As described above, the purpose of the beamforming setting is to extract the sound of interest, such as the voice detected by step 630 associated with the lip motion detected in step 620, associated with the human figure detected in step 610. As described above, extracting the sound of interest is achieved by directing the acoustic beam of a plurality of microphones in the first direction, and filter out ambient noise.

Beamforming locking procedure 600 may then proceed to step 650 to detect voice by the user, which voice is turned in the first direction. For example, apparatus 100 of FIG. 1 determines that the user's head in turned in the first direction based on one or more images received via upwards-facing camera 135. In addition, apparatus 100 detects the user's voice received via backward-facing microphone 144. Preferably, the directional hearing apparatus stores a suitable sample of the user's voice biometrics data, allowing the apparatus to ascertain that the voice received via a microphone facing the user is indeed the user's own voice.

It is appreciated that the detection operation of steps 610-650 implies that the user is engaged in a conversation with the person detected in step 610.

Following the detection of a conversation between the user and an interlocutor in the first direction, beamforming locking procedure 600 may proceed to step 660 to lock the beamforming to the first direction. This means that the beamforming will remain fixed in the first direction even when the user's head is turned to a second direction, and even if a human figure is detected in a second direction, and/or a voice is detected coming from the second direction.

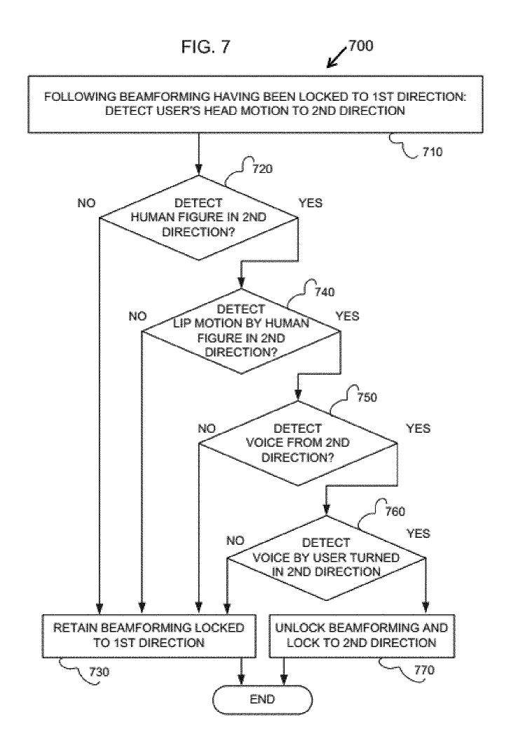

It is appreciated that the beamforming locking procedure 600 of FIG. 6 is particularly advantageous as it allows a user using a hearing aid to listen to an interlocutor in an ambient noise environment while also allowing the user to freely turn the user's sight in any direction, including in the direction of other people who are currently talking. Preferably, the hearing aid device will keep the beamforming locked to the direction of the same interlocutor as long as the user using the hearing aid device has not started a conversation with a person in another direction, as described below with reference to FIG. 7.

It is appreciated that beamforming locking procedure 600, as well as steps 640 and 660, may be augmented by BASS, and/or vice versa, for example as part of a process of sound selection, as will be further described below.

Reference is now made to FIG. 7, which is a simplified flowchart of a beamforming unlocking procedure 700, provided and employed in accordance with one embodiment. As an option, the beamforming unlocking procedure 700 of FIG. 7 may be viewed in the context of the details of the previous Figures. Of course, however, the beamforming unlocking procedure 700 of FIG. 7 may be viewed in the context of any desired environment. Further, the aforementioned definitions may equally apply to the description below.

Beamforming unlocking procedure 700 may be implemented as a software program executed by a directional hearing aid device, and particularly by a controller or processors of the external unit of a hearing aid device. For example, such hearing aid device may be similar to the hearing aid devices described above with reference to FIGS. 1, 2 and/or 3.

Typically, a central processor is executing the beamforming unlocking procedure 700 may be similar to the processor or central control unit 150 described above with reference to FIG. 1. However, beamforming unlocking procedure 700 may be operated by any CPU of any device such as external unit 220 of FIG. 2, and/or external unit 320 of FIG. 3. Directional hearing aid apparatus 100 is used herein by way of a non-limiting example.

Beamforming unlocking procedure 700 may be executed following the locking of beamforming to a first direction, such as by beamforming locking procedure 600, as described above with reference to FIG. 6.

As shown in FIG. 7, beamforming unlocking procedure 700 may start with step 710 by detecting a motion of the head of the user using the hearing aid in a second direction. For example, apparatus 100 of FIG. 1 detects a motion of the user's head via one or more images captured via camera 135. For example, upon detecting a motion of the user's chin, apparatus 100 may determine the direction to which the user has turned the user's sight, namely the second direction.

It is appreciated that the term ‘second direction’ here may mean any direction (i.e., which the user head is directed) other than the first direction, which may be the direction that the beamforming is locked to. As described above, beamforming locking procedure 600 of FIG. 6 has locked the beamforming in a first directing, thus allowing the user to move his head without invoking the beamforming alteration procedure 500. Thus the acoustic beam is retained towards the sound source of interest, even if the user's head turns away from the direction of the sound source of interest. The purpose of the beamforming unlocking procedure 700 is to determine if this locking should be terminated.

If step 710 has determined a second direction, beamforming unlocking procedure 700 may proceed to step 720 to detect a human figure in the second direction determined in step 710. For example, in apparatus 100 of FIG. 1, the second direction is covered by a wide-angle front-facing camera 130, allowing apparatus 100 to determine the presence of a human figure in the second direction based on images captured via the camera.

As described above, the directional hearing aid device may include one or more side-facing cameras, allowing the apparatus to detect the presence of a human figure if the second direction cannot be covered by the front-facing camera. If the second direction is not covered by a camera on the directional hearing aid apparatus, then step 720 may be skipped, and the procedure continues to step 750.

If, in step 720, beamforming unlocking procedure 700 did not detect a human figure in the second direction, then, beamforming unlocking procedure 700 may proceed to step 730 to retain the lock of the beamforming setting to the first direction.

The beamforming unlocking procedure 700 may thereby be terminated. However, the beamforming unlocking procedure 700 may be restarted whenever the hearing aid device determines that the user of the hearing aid device has turned his or her head in a direction that is different from the first (locked) direction, and/or the second direction (last direction checked).

If, in step 720, beamforming unlocking procedure 700 has detected a human figure in the second direction, then, beamforming unlocking procedure 700 may proceed to step 740 to detect lip motion by the human figure detected in the second direction in step 720.

For example, in apparatus 100 of FIG. 1, the second direction is covered by a wide-angle front-facing camera 130, allowing apparatus 100 to detect lip motion by a human figure in the second direction based on images captured via the camera. Preferably, a directional hearing aid device may include one or more side-facing cameras, allowing the device to detect lip motion by a human figure, if the second direction cannot be covered by a front-facing camera.

If step 740 did not detect lip motion by the human figure in the second direction, then beamforming unlocking procedure 700 may proceed to step 730 to retain the lock to the first direction as described above.

If step 740 has detected lip motion by the human figure in the second direction, then, beamforming unlocking procedure 700 may proceed to step 750, to detect human voice coming from the second direction. For example, hearing aid device 100 may use input received via an array of microphones 141-144 to detect the human voice coming from the second direction.

If step 740 did not detect human voice coming from the second direction, then, beamforming unlocking procedure 700 may proceed to step 730 to retain the lock to the first direction as described above.

If step 740 has detected human voice coming from the second direction, then, beamforming unlocking procedure 700 may proceed to step 760 to detect the direction of the voice of the user of the hearing aid device. It is appreciated that in block 710 it has already been established that the user's head is turned in the second direction.

For example, apparatus 100 of FIG. 1 may detect the user's voice received via backward-facing microphone 144. Preferably, the directional hearing device stores a suitable sample of the user's voice biometrics data, allowing the device to ascertain that the voice received via a microphone facing the user is indeed the user's own voice.

If the user's own voice is not detected (in step 760), then beamforming unlocking procedure 700 may proceed to step 730 to retain the lock to the first direction as described above.

If step 760 has detected the user's own voice, then then beamforming unlocking procedure 700 may proceed to step 770 to unlock the beamforming lock to the first direction, and then to lock it in the second direction. And the procedure is thereby terminated.

As it has already been determined in block 710 that the user's sight is turned in the second direction, it is appreciated that the detection of the user's voice in decision block 760 implies that the user is possibly engaged in a conversation with the person detected in block 720.

It is appreciated that beamforming unlocking procedure 700, as well as steps 730 and 740, may be augmented by BASS, and/or vice versa, as part of a process of sound selection, as will be further described below.

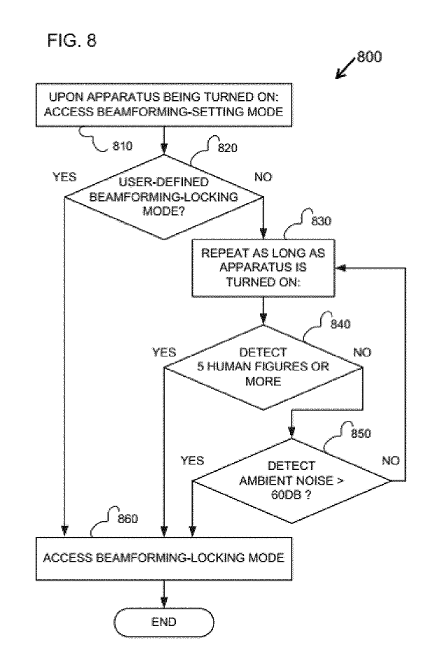

Reference is now made to FIG. 8, which is a simplified flowchart of a locking mode access procedure 800, provided and employed in accordance with one embodiment. As an option, locking mode access procedure 800 of FIG. 8 may be viewed in the context of the details of the previous Figures. Of course, however, the locking mode access procedure 800 of FIG. 8 may be viewed in the context of any desired environment. Further, the aforementioned definitions may equally apply to the description below.

Locking mode access procedure 800 may be implemented as a software program executed by a directional hearing aid device, and particularly by a controller or processors of the external unit of a hearing aid device. For example, such hearing aid device may be similar to the hearing aid devices described above with reference to FIGS. 1, 2 and/or 3.

Typically, a central processor is executing the locking mode access procedure 800 may be similar to the processor or central control unit 150 described above with reference to FIG. 1. However, locking mode access procedure 800 may be operated by any CPU of any device such as external unit 220 of FIG. 2, and/or external unit 320 of FIG. 3. Directional hearing aid apparatus 100 is used herein by way of a non-limiting example.

Locking mode access procedure 800 may be typically executed as soon as the hearing aid device is turned on. However, locking mode access procedure 800 may be executed in other circumstances as well.

As shown in FIG. 8, locking mode access procedure 800 may start with step 810, typically following the turning on of a directional hearing aid device, the device activates beamforming setting mode 400 of FIG. 4. This can be considered as a default mode, where the device may set the beamforming in the direction of an assumed interlocutor (first direction). However, beamforming may not yet be locked in that (first) direction. The beamforming can be automatically readjusted in the direction of another assumed interlocutor, for example by invoking beamforming alteration procedure 500 of FIG. 5. Examples of beamforming setting mode are described above with reference to FIGS. 4 and 5.

Locking mode access procedure 800 may then proceed to step 820 to accept a user-defined access to beamforming locking mode. This is a mode wherein the hearing aid device may lock the beamforming in the direction of an assumed interlocutor. The beamforming remains locked in the direction of a first interlocutor, even if another interlocutor is detected; the beamforming s typically unlocked only if a conversion is detected between the user and the second interlocutor. Examples of beamforming locking mode are described above with reference to FIGS. 6 and 7.

A directional hearing aid apparatus, which might be similar to the apparatus described in FIGS. 1-3 preferably comprises a suitable user interface allowing a user to define the access to beamforming-locking mode. If the user has defined access to beamforming locking mode, then, in block 860, the hearing aid device may invoke beamforming locking mode, and the procedure is thereby terminated.

Locking mode access procedure 800 may allow the user to define access to beamforming setting mode via a user interface at any time, and the locking mode access procedure 800 may then restart.

If the user has not defined access to beamforming locking mode, then by default the hearing aid device may remain in beamforming setting mode, and, in block 830, the apparatus enters a mode-access routine that may repeat as long as the apparatus remains turned on.

Then, in step 840, the locking mode access procedure 800 may determine whether a predetermined number of human objects are detected in the environment of the user. In the example of step 840 this predetermined number is five or more human objects (e.g., people, persons, figures).

For example, apparatus 200 described above with reference to FIG. 2, may determine the number of human figures in the environment based on images captured via cameras 230, 235 and/or 236.

If the predetermined number (e.g., 5 or more) of human figures are detected, then Locking mode access procedure 800 may proceed to step 860 to invoke beamforming locking mode, and the procedure is thereby terminated.

If locking mode access procedure 800, in step 840, did not detect the predetermined number of people (5 or more human figures), then locking mode access procedure 800 may proceed to step 850 to determine whether the ambient noise in the user's environment exceeds a predetermined value. For example, 60 dB, which is a typical lower limit for human voices in a public place. For example, hearing aid device 200 may determine the ambient noise in the user's environment based on input via microphones 241-244.

If an ambient noise exceeding the predetermined value (e.g., 60 dB) is detected, then locking mode access procedure 800 may proceed to step 860 to invoke beamforming locking mode, and the procedure is thereby terminated.

As described above, the user ma manually define access to beamforming setting mode via the user interface, and the procedure is then restarted.

If no ambient noise exceeding 60db is detected, then by default the hearing aid device may remain in beamforming setting mode, and the procedure returns to block 830, thereby to reenter the mode-access routine that is preferably repeated as long as the apparatus remains turned on.

It is appreciated that locking mode access procedure 800 may be augmented by BASS, and/or vice versa, as part of a process of sound selection, as will be further described below.

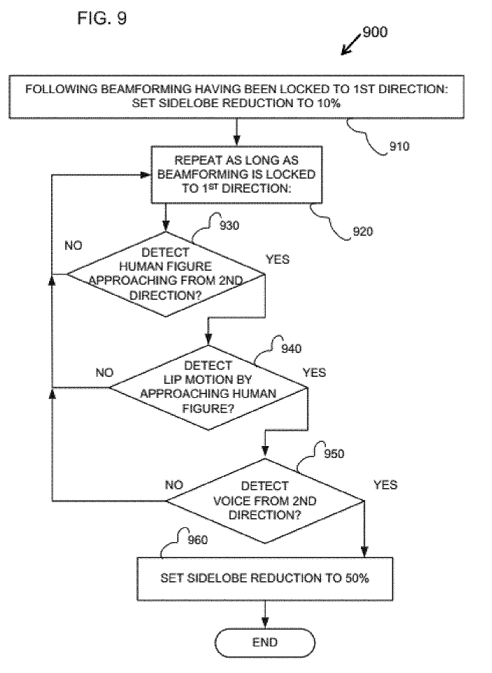

Reference is now made to FIG. 9, which is a simplified flowchart of a side-lobe reduction setting procedure 900, provided and employed in accordance with one embodiment. As an option, side-lobe reduction setting procedure 900 of FIG. 8 may be viewed in the context of the details of the previous Figures. Of course, however, the side-lobe reduction setting procedure 900 of FIG. 8 may be viewed in the context of any desired environment. Further, the aforementioned definitions may equally apply to the description below.

Side-lobe reduction setting procedure 900 may be implemented as a software program executed by a directional hearing aid device, and particularly by a controller or processors of the external unit of a hearing aid device. For example, such hearing aid device may be similar to the hearing aid devices described above with reference to FIGS. 1, 2 and/or 3.

Typically, a central processor is executing side-lobe reduction setting procedure 900 of may be similar to the processor or central control unit 150 described above with reference to FIG. 1. However, side-lobe reduction setting procedure 900 may be operated by any CPU of any device such as external unit 220 of FIG. 2, and/or external unit 320 of FIG. 3. Directional hearing aid apparatus 100 is used herein by way of a non-limiting example.

Side-lobe reduction setting procedure 900 may be typically executed following the locking of beamforming to a first direction, such as by beamforming locking procedure 600, as described above with reference to FIG. 6. However, locking mode access procedure 800 may be executed in other circumstances as well.

Typically, following the turning on of a directional hearing aid device, the device activates beamforming setting mode 400 of FIG. 4. This can be considered as a default mode, where the device may set the beamforming in the direction of an assumed interlocutor (first direction). However, beamforming may not yet be locked in that (first) direction. The beamforming can be automatically readjusted in the direction of another assumed interlocutor, for example by invoking beamforming alteration procedure 500 of FIG. 5. Examples of beamforming setting mode are described above with reference to FIGS. 4 and 5.

Beamforming locking procedure 600 may then be activated to lock beamforming to the first direction, to allow the user's head to move without disrupting or adversely affecting the current beamforming (e.g., towards the first direction). Beamforming unlocking procedure 700 may then be activated to unlock beamforming if needed.

Locking mode access procedure 800 may be executed as soon as the hearing aid device is turned on, and may thereafter be executed in parallel, or in the same time, or simultaneously with other procedures, as necessary.

Side-lobe reduction setting procedure 900 may start when following the locking of beamforming to a first direction, and may thereafter be executed in parallel, or in the same time, or simultaneously with other procedures, as necessary.

As shown in FIG. 9, side-lobe reduction setting procedure 900 may start with step 910 following the locking of beamforming in a first direction, as described above, and continue to step 920 to repeat as long as beamforming is locked.

It is appreciated that a side-lobe reduction level may be set to a first predetermined value, for example, 10%. Thereafter, while the apparatus is locked to a voice coming from the first direction, sounds from all other directions are reduced to the predetermined level, which may be considered the default reduction level, and in the current example is 10%.

Then, in step 920 the side-lobe reduction setting procedure 900 may initiate a subroutine to be repeated as long as the beamforming is locked to the first direction.

In step 930, the side-lobe reduction setting procedure 900 may determine whether a human figure is approaching from a second direction. Apparatus 200, for example, may detect an approaching human figure based on a stream of images received via one or more of cameras 230, 235 and 236. As long as no approaching human figure is detected, the procedure returns to the operation of block 920 and the subroutine is repeated.

If an approaching human figure is detected in step 930, then side-lobe reduction setting procedure 900 may proceed to step 940 to determine whether lip motion by the approaching human figure can be detected. Apparatus 200, for example, may detect lip motion by an approaching human figure based on a stream of images received via one or more of cameras 230, 235 and 236. As long as no lip motion by the approaching human figure is not detected, the procedure returns to the operation of block 920, and the subroutine is repeated.

If side-lobe reduction setting procedure 900 does not detect lip motion in step 940 for the approaching human figure, side-lobe reduction setting procedure 900 may proceed to step 950 to detect voice from the second direction. Apparatus 200, for example, may detect voice from the specific direction based on input received via one or more of microphones 241-4. As long as no voice from the second direction is detected, the procedure may proceed step 920 and the subroutine is repeated.

If side-lobe reduction setting procedure 900 detects voice in step 940, side-lobe reduction setting procedure 900 may proceed to step 960 to adjust the side-lobe reduction level to a second predetermined value, which may typically be higher than the first predetermined value. Such second predetermined value may be, for example, 50%. Therefore increasing the volume of sound from the surrounding provided to the user (in addition to the main voice that is extracted by the beamforming function). The procedure may then be terminated.

It is appreciated that the side-lobe reduction setting procedure 900 may be particularly appropriate for a directional hearing aid apparatus in the following scenario: In a restaurant, for example, the hearing aid device locks the beamforming, thereby allowing the user to listen to an interlocutor with whom the user is engaged in a conversation. Sounds from all other direction are initially reduced to 10%. Once it is detected that a person approaches the user from another direction and talks in the direction of the user, then the apparatus adjusts the reduction level to 50%, allowing the user to listen more clearly to the approaching person, such as a waiter, for example, while retaining the locking of the beamforming to the main interlocutor.

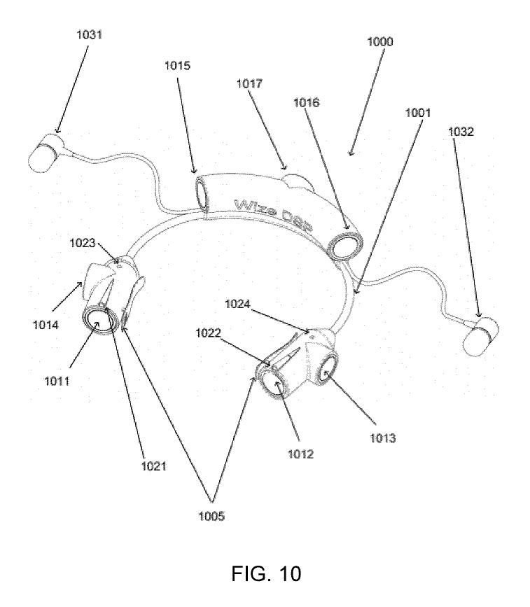

Reference is now made to FIG. 10, which is an isometric illustration of a directional hearing aid device 1000, in accordance with one embodiment. As an option, directional hearing aid device 1000 of FIG. 10 may be viewed in the context of the details of the previous Figures. Of course, however, directional hearing aid device 1000 of FIG. 10 may be viewed in the context of any desired environment. Further, the aforementioned definitions may equally apply to the description below.

Turning to FIG. 10, it is seen that a directional hearing aid device 1000 may be similar to apparatus 200 described above with reference to FIG. 2. Directional hearing aid device 1000 may include a flexible construction 1001 that is suitable to be mounted on a user's collar. Construction 1001 may include one or more suitable clips 1005 and can be attached either on, or underneath, a user's collar, to be less visible.

As also seen in FIG. 10, directional hearing aid device 1000 may include a plurality of microphones. In the example shown in FIG. 10, directional hearing aid apparatus 1000 may include two front-facing microphones 1011 and 1012, two side-facing microphones 1013 and 1014, two microphones 1015 and 1016 located near the nape of the user's neck, and face partially to the user's sides, and a back-facing microphone 1017.

Microphones 1011-1017 may include one or more miniaturized microphones, thereby by to allow the entire construction of directional hearing aid device 1000 to be more compact, easier to be collar-mounted and less visible. Microphones 1011-1017 typically form a microphone array, thereby to allow the operation of beamforming.

As further seen in FIG. 10, directional hearing aid device 1000 may include a plurality of cameras. In the example shown in FIG. 10, directional hearing aid device 1000 may include two front-facing cameras 1021 and 1022, and two upward-facing cameras 1023 and 1024.

Front-facing cameras 1021 and 1022 may capture images, such as human figures, in front of the user wearing directional hearing aid device 1000 (hereinafter the ‘user’). Cameras 1023 and 1024 may therefore be wide angle cameras. Cameras 1023 and 1024 may also capture lip motion of a human figure in front of the user.

Cameras 1023 and 1024 capture images of the user's head, chin and/or beard, thereby allowing detection of the direction in which the user's head is turned. Alternately, or in addition, at least one of cameras 1021 and 1022 includes a suitable convex lens allowing sufficiently wide-angled view, to capture images of the user's head, Thus allowing directional hearing aid device 1000 to function without the upward-facing cameras.

As also seen in FIG. 10, directional hearing aid device 1000 may include two earpieces 1031 and 1032 that are suitable to be plugged into the user's ears. Connected to collar-mounted construction 1001, earpieces 1031 and 1032 can easily be plugged into the user ears with relatively short wires. Preferably, at least one of earpieces 1031 and 1032 includes a suitable accelerometer to detect motions of the user's head, and thus to determine the direction in which the user's head is turned.

Alternately or in addition, directional hearing aid device 1000 may connect, preferably wirelessly, to one or two external earpieces, For example, Bluetooth-enabled headphones and/or one or two ear-mounted hearing aids.

Typically, directional hearing aid device 1000 may include a suitable wireless communication module that is operative to communicate with the one or two earpieces.

Based on input via microphones 1011-1017, via cameras 1021-1024 and/or via at least one accelerometer in earpieces 1031 and 1032, directional hearing aid apparatus 1000 may perform beamforming that takes into account the presence of human figures in the vicinity of the user, lip motion by such figures, voice from such figures and/or the direction in which a user's head is turned.

Directional hearing aid device 1000 may therefore extract from an ambient noise the voice of a most likely interlocutor of the user, and to deliver to the user the audio signal of this voice via earpieces 1031 and 1032.

It is also appreciated that apparatus 1000 of FIG. 10 is particularly appropriate for performing the beamforming procedures described above with reference to FIGS. 4-9.

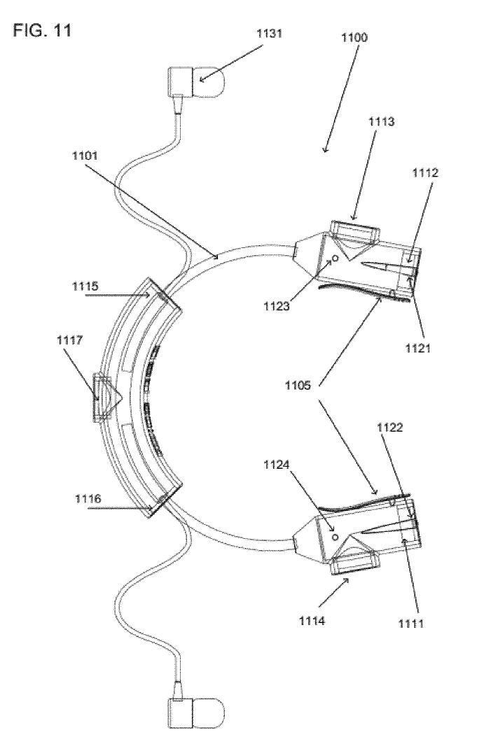

Reference is now made to FIG. 11, which is top-view section of a directional hearing aid device 1100, in accordance with one embodiment. As an option, directional hearing aid device 1100 of FIG. 11 may be viewed in the context of the details of the previous Figures. Of course, however, the directional hearing aid device 1100 of FIG. 11 may be viewed in the context of any desired environment. Further, the aforementioned definitions may equally apply to the description below.

Turning to FIG. 11, it is seen that directional hearing aid device 1100 may be similar to apparatus 1000 described above with reference to FIG. 10. Directional hearing aid device 1100 nay include flexible construction 1101 typically suitable to be mounted on a user's collar. Construction 1101 may include one or more suitable clips 1105 and can be attached either on or underneath a user's collar, thereby to be less visible.

As also seen in FIG. 11, directional hearing aid device 1100 may include a plurality of microphones, such as the seven microphones shown in FIG. 11. Directional hearing aid device 1100 may include two front-facing microphones 1111 and 1112, two side-facing 1113 and 1114, two microphones 1115 and 1116 that are located near the nape of the user's neck, and face partially to the user's sides, and a back-facing microphone 1117. Microphones 1111-1117 preferably include one or more miniaturized microphones, thereby by to allow the entire construction of apparatus 1100 to be more compact, easier to be collar-mounted and less visible. Microphones 1111-1117 typically form a microphone array, thereby allowing the operation of beamforming.

As further seen in FIG. 11, directional hearing aid apparatus 1100 comprises a plurality of cameras, 4 in the example of FIG. 11. Directional hearing aid device 1100 may include two front-facing cameras 1121 and 1122, and two upward-facing cameras 1123 and 1124.

Front-facing cameras 1121 and 1122 capture images of human figures in front of the user, preferably in a wide angle, and are preferably also operative to capture lip motion. Cameras 1123 and 1124 capture images of the user's head, chin and/or beard, thereby allowing detection of the direction in which the user's head is turned.

Alternately or in addition, at least one of cameras 1121 and 1122 may include a suitable convex lens allowing a sufficiently wide-angled view, thereby to capture images of the user's head, allowing apparatus 1100 to function without resort to upward-facing cameras.

As also seen in FIG. 11, directional hearing aid device 1100 may include two earpieces 1131 and 1132 that are suitable to be plugged into the user's ears. Connected to collar-mounted construction 1101, earpieces 1131 and 1132 can easily be plugged into the user ears with relatively short wires. Preferably, at least one of earpieces 1131 and 1132 may include a suitable accelerometer that is operative to detect motions of the user's head, thereby allowing apparatus 1100 to determine the direction in which the user's head is turned.

Alternately or in addition, directional hearing aid device 1100 may connect, preferably wirelessly, to one or two external earpieces. For example, Bluetooth-enabled headphones and/or one or two ear-mounted hearing aids.

Typically, directional hearing aid device 1100 may include a suitable wireless communication module that is operative to communicate with the one or two earpieces.

Based on input via microphones 1111-1117, via cameras 1121-1124 and/or via at least one accelerometer in earpieces 1131 and 1132 directional hearing aid device 1100 may perform beamforming that takes into account the presence of human figures in the vicinity of the user, lip motion by the figures, voice by the figures and/or the direction in which the user's head is turned. directional hearing aid device 1100 may therefore be operative to extract from the ambient noise the voice of a most likely interlocutor of the user and to deliver to the user the audio signal of the voice via external earpieces with which directional hearing aid device 1100 may include communicates, preferably wirelessly.

It is also appreciated that directional hearing aid device 1100 may include is particularly appropriate for performing the beamforming procedures described above with reference to FIGS. 4-9.

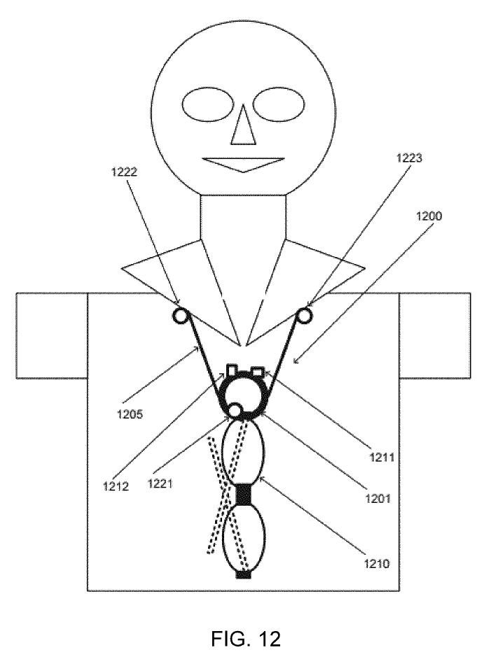

Reference is now made to FIG. 12, which is a simplified schematic illustration of an eyeglass holder directional hearing aid device 1200, in accordance with one embodiment. As an option, eyeglass holder directional hearing aid device 1200 of FIG. 12 may be viewed in the context of the details of the previous Figures. Of course, however, eyeglass holder directional hearing aid device 1200 of FIG. 12 may be viewed in the context of any desired environment. Further, the aforementioned definitions may equally apply to the description below.

Turning to FIG. 12 it is sees that eyeglass holder directional hearing aid device 1200 may include a ring 1201 that is tied to a string 1205, which is hung around a user's neck, typically underneath the user's collar. A pair of eyeglasses 1210 may be held by ring 1201 like in a regular eyeglass holder.

As also seen in FIG. 12, eyeglass holder directional hearing aid device 1200 may include two cameras at the upper part of ring 1201, including: a front-facing camera 1211 and an upward-turned camera 1212. Camera 1211 is operative to capture images of persons in front of the user, preferably at a wide angle, and is preferably also operative to capture lip motion. Camera 1212 is operative to capture images of the user's head, chin and/or beard, thereby to allow detection of the direction in which the user's head is turned.

As further seen in FIG. 12, eyeglass holder directional hearing aid device 1200 may include a plurality of microphone. The example shown in FIG. 12 includes six microphones: a front-facing microphone 1221 at the lower part of ring 1201, two microphones 1222 and 1223 on string 1205, which microphones are front-facing and preferably slightly turned to the sides on each corner of the collar, and three more microphones not shown in FIG. 12, which may be connected to string 1205 at the back of the user, including one backwards-facing microphone, and two that are backwards-facing and slightly turned to the sides.

The three backwards-facing microphones are preferably operative to receive sound through the collar cloth. Alternately or in addition, the backwards-facing microphones are hung from string 2015 on the user's backside slightly below the collar's level. Typically, all microphones function as a single microphone array, thereby allowing beamforming operation.

Apparatus 1200 may also include a suitable battery, a central processor and a wireless communication module. These components may be located at the backside of apparatus 1200, on string 1205, typically underneath the collar. The central processor may receive input from cameras 1211 and 1212, and from microphones 1221-1223 and the three backwards-facing microphones, and may perform beamforming for these microphones.

The wireless module may be operative to communicate with one or two earpieces, headphones and/or one or two ear-plugged hearing aids, thereby to deliver to the user an audio signal of the voice extracted by apparatus 1200.

Based on input via microphones 1221-1223, via the three backwards-facing microphones and via cameras 1211 and 1212, directional hearing aid apparatus 1200 may perform beamforming that takes into account the presence of human figures in the vicinity of the user, lip motion by the figures, voice by the figures and/or the direction in which the user's head is turned. Apparatus 1200 may therefore extract from an ambient noise the voice of a most likely interlocutor of the user and to deliver to the user the audio signal of the voice via external earpieces with which eyeglass holder directional hearing aid device 1200 may communicates, preferably wirelessly.

It is appreciated that the construction of apparatus 1200 as an eyeglass holder is particularly appropriate for a hearing aid apparatus, as it creates an impression of a regular accessory which is not associated with a hearing aid, thereby to make apparatus 1200 more agreeable for the user to carry in public places and the like.

It is also appreciated that apparatus 1200 of FIG. 12 is particularly appropriate for performing the beamforming procedures described above with reference to FIGS. 4-9.

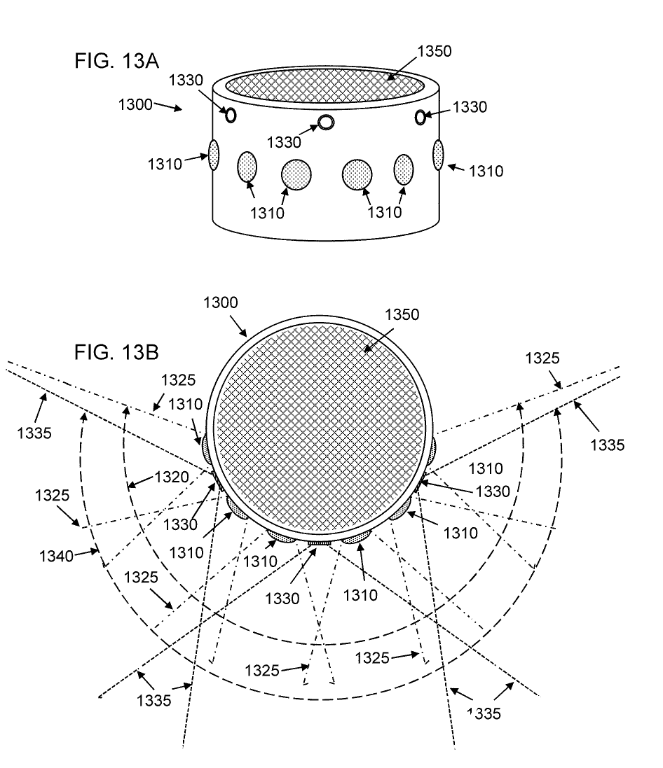

Reference is now made to FIG. 13A, which is a simplified perspective illustration of a smart speaker device 1300, and to FIG. 13B, which is a simplified top view illustration of the smart speaker device 1300, both in accordance with an embodiment of the present invention.

As an option, the illustrations of the smart speaker 1300 of FIG. 13 may be viewed in the context of the details of the previous Figures. Of course, however, the illustrations of the smart speaker 1300 of FIG. 13 may be viewed in the context of any desired environment. Further, the aforementioned definitions may equally apply to the description below.

The purpose of the smart speaker 1300 of FIG. 13 is to provide a user, or another system, with a selected sound emitted by and/or received from a selected human speaker, by combining object detection and sound selection. For example, by using image object detection, blind audio source separation, and beamforming. Any other technology or combination of technologies for object detection, and any other technology, and any combination of such technologies, are contemplated herein.

It is appreciated that the system and method described herein for the smart speaker 1300 are also operative and useful for any of the hearing aid devices described above, as well as to multi-user tele-conferencing systems as used, for example, in conference rooms. The system and methods described herein are presented for a smart-speaker by way of example.

It is appreciated that the method described herein for a single smart speaker 1300 is also operative and useful for any number of smart speakers 1300 operating together, for example under the control of another computer, or under the control of any one of the smart speakers 1300 of the plurality of smart speakers 1300 operating together. For example, such smart speakers 1300 may be distributed in a room to cover a plurality of speakers in various directions.

As shown in FIGS. 13A and 13B smart-speaker 1300 may include a plurality of microphones 1310 distributed in at least a wide sector (angle) 1320 around the smart-speaker 1300. It is appreciated that the plurality of microphones may be distributed around the smart-speaker in 360 degrees to cover speakers from all directions. It is appreciated, for example, that the plurality of microphones may be distributed around a wall mounted smart-speaker in 180 degrees. It is appreciated, for example, that the plurality of microphones may be distributed around a ceiling mounted smart-speaker, or a table mounted smart-speaker, to cover a hemisphere. However, any type of wide angle distribution is contemplated.

The plurality of microphones 1310 may be directional, each having a beam 1325, and the beams 1325 may be overlapping to enable beamforming. Beamforming may enable stirring a virtual beam in a direction between the main directions of the beams of the microphones.

As shown in FIGS. 13A and 13B smart-speaker 1300 may also include one or more cameras 1330 distributed in at least a wide sector (angle) 1340 around the smart-speaker 1300. The plurality of cameras 1330 may each cover s sector 1335, and the sectors 1335 may be overlapping to cover wide sector (angle) 1340. Optionally but typically, wide sector (angle) 1340 is equal or larger than wide sector (angle) 1320.

As shown in FIGS. 13A and 13B smart-speaker 1300 may also include one or more outputs, for example, a speaker 1350, and or a communication device (not shown in FIG. 1300) communicatively coupled to an external device or system. Such external device or system may be an earpiece such as shown and described with reference to any of FIGS. 1, 2 and 3. Such external device or system may be another local computer and/or a remote server (including a cloud server). Such communicative device may use a wired (cable) or wireless connectivity and/or technology.

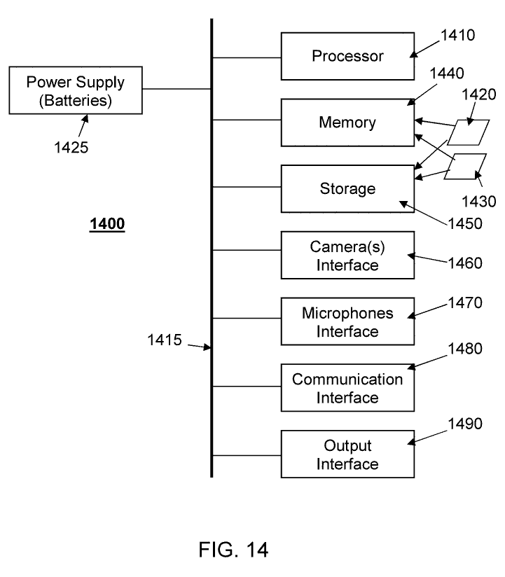

Reference is now made to FIG. 14, which is a simplified electric schematic of a computing device 1400, in accordance with an embodiment of the present invention. As an option, the illustrations of the schematic of a computing device 1400 of FIG. 14 may be viewed in the context of the details of the previous Figures. Of course, however, the schematic of a computing device 1400 of FIG. 14 may be viewed in the context of any desired environment. Further, the aforementioned definitions may equally apply to the description below.

Computing device 1400 may represent an example of the electric structure and components of smart speaker device 1300 of FIGS. 13A and 13Bm as well as the hearing aid devices of FIGS. 1, 2 and 3, such as the external devices as shown and described with reference to FIGS. 1, 2 and 3.

Computing device 1400 may include a processor or a microcontroller 1410 operative to process one or more software programs, such as software program 1420, and/or execute computer instructions thereof, and or process data such as data 1430.

Computing device 1400 may also include one or more memory devices 1440, which may contain one or more software programs 1420, and/or data 1430.

Computing device 1400 may also include one or more storage devices 1450, which may also contain the one or more software programs 1420, and/or data 1430.

Computing device 1400 may also include one or more camera interfaces 1460, which may communicatively couple processor 1410 with one or more imaging devices such as a camera. However, any type of imaging device or combinations of imaging technologies are contemplated.

Computing device 1400 may also include one or more microphone interfaces 1470, which may communicatively couple processor 1410 with one or more imaging microphones.

Computing device 1400 may also include one or more communication interfaces 1480, which may communicatively couple processor 1410 with one or more external device. Such external device may be an earpiece such as shown and described with reference to FIGS. 1, 2 and 3. An external device may also be a local computer or a remote server (e.g., a cloud-based computing service). The communication technologies may include wired communication technologies as well as wireless communication technologies.

Computing device 1400 may also include one or more output interfaces 1490, which may communicatively couple processor 1410 with one or more output devices, such as a speaker.

Computing device 1400 may also include a bus 1415 and a power supply or batteries 1425.

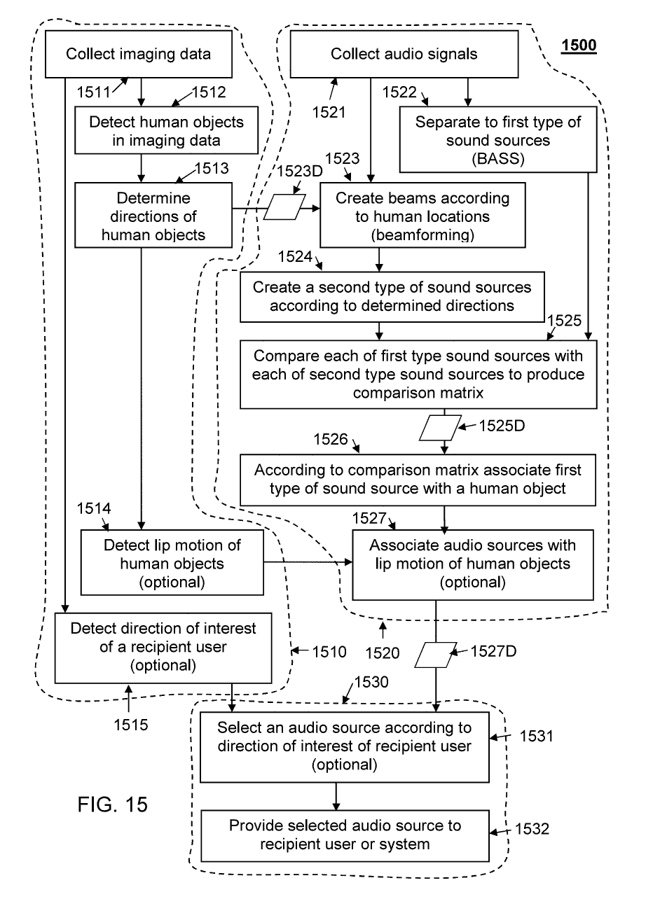

Reference is now made to FIG. 15, which is a simplified flow chart of a software program 1500 for processing sound source selection, in accordance with an embodiment of the present invention. As an option, the flow chart of FIG. 15 may be viewed in the context of the details of the previous Figures. Of course, however, the flow chart of FIG. 15 may be viewed in the context of any desired environment. Further, the aforementioned definitions may equally apply to the description below.

Software program 1500 may be processed, for example, by processor 1410 of computing device 1400 of FIG. 14 or by any of the processors of the computing devices shown and described with reference to FIGS. 1, 2, 3, 13A and 13B. Software program 1500 may be, stored, for example, in memory device 1440 and/or storage device 1440, for example, as part of software program 1420. Software program 1500 may process data such as data 1430.

Software program 1500 may include an imaging process 1510, and acoustic process 1520, and a selection process 1530, which may be processed in parallel and communicate with each other.

Imaging process 1510 may start with software module 1511 by collecting imaging data from cameras, such as via camera interface 1460 of FIG. 14. Imaging process 1510 may then continue with software module 1512 to detect human objects in the collected imaging data, and particularly images of heads of human objects. Imaging process 1510 may then proceed to software module 1513 to detect the direction of each of the detected human objects. The directions may be determined, for example, with respect to the camera system, such as the camera system of cameras 1310 of smart speaker device 1300 of FIGS. 13A and 13B. For example, the directions may be determined, for example, with respect to wide sector (angle) 1340 as shown and described with reference to FIG. 13B.

Optionally, imaging process 1510 may proceed to software module 1514 to detect lip motion by any of the detected human objects.

Optionally by preferably, imaging process 1510 may also use user-analysis software module 1515 to process imaging data received from the camera(s) to detect the orientation, and/or direction, in which the head of a particular user (human object) is directed or oriented, which is considered to be the direction of interest of that user.

Acoustic process 1520 may start with software module 1521 by collecting audio signals, or microphone audio streams, from microphones, such as microphones 1330 of the smart speaker device 1300 or FIGS. 13A and 13B, for example via microphone interface 1470 of FIG. 14.

Acoustic process 1520 may then proceed to source separation software module 1522 to analyze the microphone audio streams and separate them into one or more audio sources. Thus creating one or more source audio streams each associated with a different source. This source audio streams may be termed herein ‘first type of sound sources’. Software module 1522 may use blind (audio) source separation technology for separating microphone audio streams into source audio streams. However, any other similar technology may be used.

Acoustic process 1520 may then proceed to beamforming software module 1523, typically in parallel to processing software module 1522. Software module 1523 may receive from imaging process 1510 one or more directions (1523D) of human objects. That is directions, respective to, for example, smart speaker device 1300 or FIGS. 13A and 13B, in which imaging process 1510 detected human objects, preferably human object for which imaging process 1510 detected lip motion. Beamforming software module 1523 may then use two or more microphones, such as microphones 1310 of smart speaker device 1300 or FIGS. 13A and 13B, to form an acoustic beam directed at one of the directions received from imaging process 1510.

Acoustic process 1520 may then proceed to beamforming software module 1524 to create an audio stream for each of the beams. That is, for each of the directions received from imaging process 1510. These beam-related audio streams, and/or direction-related audio streams, may be termed herein ‘second type of sound source’.

Acoustic process 1520 may then proceed to analysis software module 1525 to compare each source audio stream (first type of sound source) with each beam-related audio stream (second type of sound source).

Such comparison may create, for example, a comparison matrix (1525D). The comparison matrix may include a cell for each pair of source audio stream (first type of sound source) and beam-related audio stream (second type of sound source). The analysis software module 1525 may compare each of these pair an enter into such cell a score representing, for example, the probability that the source audio stream (first type of sound source) is related to the respective beam-related audio stream (second type of sound source).

Acoustic process 1520 may then proceed to stream association software module 1526 to associate one or more of the source audio stream (first type of sound source) with one of the human objects detected by imaging process 1510. Stream association software module 1526 may use, for example, a comparison matrix created by analysis software module 1525. For example, stream association software module 1526 may analyze the respective rows and columns to determine which source audio stream (first type of sound source) is more likely to be received from the direction of the particular human object. For example, rows may represent a source audio streams (first type of sound sources) and the columns may represent directions (or beams), or vice-versa.

Optionally, acoustic process 1520 may proceed to lip association software module 1527 to further associate source audio streams (first type of sound sources) with human objects. For example, lip association software module 1527 may compare the characteristics (such as volume) of each source audio stream with the occurrence of lip motion for a particular human object. This may be useful if, for example, the comparison matrix is inconclusive for, for example, a particular row or column.

Thus, the stream association software module 1526 may create a map (1527D) of human objects (as determined by imaging process 1510) and their associated source audio stream (first type of sound source) as determined using beamforming module 1523.

Selection process 1530 may then receive from imaging process 1510 the direction of interest of the user (as described above with reference to user-analysis software module 1515), and map (1527D). Selection process 1530 may then execute selection module 1531 to determine the human object to whom the user is listening and to select the source audio stream (first type of sound source) that is associated with this human object (or the direction associated with the particular human object).

Selection process 1530 may then proceed to output module 1532 to provide the selected source audio stream (first type of sound source) to an external system, or a user, for example, using the communication interface 1480 of FIG. 14. As described above, such external system may be an earpiece such as shown and described with reference to FIGS. 1, 2 and 3, a local computer, a remote server (e.g., a cloud-based computing service), etc.

It is appreciated that certain features of the invention, which are, described in the context of different embodiments, may also be provided in combination in a single embodiment. Conversely, various features of the invention, which are, for brevity, described in the context of a single embodiment, may also be provided separately or in any suitable sub-combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. In addition, citation or identification of any reference in this application shall not be construed as an admission that such reference is available as prior art to the present invention.

What is claimed is:

1. A sound selection device comprising:
a plurality of microphones mounted in at least a wide sector around said device;
a at least one camera mounted on said device to collect imaging data from said at least wide sector around said device;
a processor operative to:
process sound source separation on sound input received from said plurality of microphones to create a plurality of first sound streams, each first sound stream associated with a source of sound;
detect in said imaging data at least one image of a first human object;
determine a first direction within said at least wide sector for at least one of said first human objects;
for at least one of said first directions, form an acoustic beam, using said plurality of microphones, said acoustic beam being directed at said first direction to produce a second sound stream;
compare said second sound stream with each of said first sound streams to form a plurality of comparison results; and
associate a selected first sound stream with said human object according to a best-fit comparison result.

2. A sound selection device according to claim 1, additionally comprising:
a communicating interface;
wherein said processor additionally operative to communicate a selected first sound stream, via said communication interface, to at least one of a user and an external device.

3. A sound selection device according to claim 1, additionally comprising:
said processor additionally operative to:
acquire a second imaging data from said at least one camera;
detect in said second imaging data an image of a head of a second human object;
detect a direction of orientation of said head of said second human object with respect to said at least wide sector;
determine a selected first human object closest to said direction of orientation of said head of said second human object; and
select a first sound stream of said plurality of first sound streams associate with said selected first human object.

4. A sound selection device according to claim 3, additionally comprising:
a second camera mounted on a said device pointed in a second direction different than said at least wide sector to collect second imaging data from said second direction;
wherein said second camera providing acquiring said second imaging data.

5. A sound selection device according to claim 1, wherein said processor is additionally operative to:
detect lip motion for at least one first human object; and
determine said first direction according to said first human object for whom lip motion is detected.

6. A hearing-aid device comprising:
a plurality of microphones mounted on a first side of said hearing-aid device;
a first camera mounted on said first side of said hearing-aid device;
a second camera mounted on a second side of said hearing-aid device;
a processor operative to:
detect, in imaging data provided by said second camera, a direction of orientation of a head of a first user;
detect, in imaging data provided by said first camera, within said direction of said head of said first user, a second user talking;
form an acoustic beam, using said plurality of microphones, said acoustic beam being directed at said second user; and
collect acoustic signal via said acoustic beam.

7. The hearing-aid device according to claim 6, wherein said second side is substantially in the opposite side of said first side.

8. The hearing-aid device according to claim 6, wherein said imaging data provided by said first camera within said direction of said head of said first user, comprises a sector of a predefined angle around said direction of said head of said first user.

9. The hearing-aid device according to claim 6, additionally comprising:
a communication interface communicatively coupling said processor to an ear-mounted unit;
wherein said processor is additionally operative to provide said acoustic signal to said ear-mounted unit.

10. The hearing-aid device according to claim 9,
wherein said ear-mounted unit comprises an accelerometer operative to measure motion of said head of said first user to from head motion measurement; and
wherein said processor is additionally operative to detect, in imaging provided by said second camera, a direction of a head of a first user, according to said head motion measurement.

11. A method for sound selection, the method comprising:
processing sound source separation on sound input received from a plurality of microphones mounted in at least a wide sector around a device, to create a plurality of first sound streams, each first sound stream associated with a source of sound;
detecting at least one image of a first human object, in imaging data acquired from at least one camera mounted on said device to collect imaging data from said at least wide sector around said device;
determining a first direction within said at least wide sector for at least one of said first human objects;
forming an acoustic beam, for at least one of said first directions, using said plurality of microphones, said acoustic beam being directed at said first direction to produce a second sound stream;
comparing said second sound stream with each of said first sound streams to form a plurality of comparison results; and
associating a selected first sound stream with said human object according to a best-fit comparison result.

12. A method for sound selection according to claim 11, the method additionally comprising:
communicating a selected first sound stream to at least one of a user and an external device.

13. A method for sound selection according to claim 11, the method additionally comprising:
acquiring a second imaging data from said at least one camera;
detecting in said second imaging data an image of a head of a second human object;
detecting a direction of orientation of said head of said second human object with respect to said at least wide sector;
determining a selected first human object closest to said direction of orientation of said head of said second human object; and
selecting a first sound stream of said plurality of first sound streams associate with said selected first human object.

14. A method for sound selection according to claim 13, the method additionally comprising:
providing a second camera mounted on a said device pointed in a second direction different than said at least wide sector to collect second imaging data from said second direction;
wherein said second camera acquiring said second imaging data.

15. A method for sound selection according to claim 11, the method additionally comprising:
detecting lip motion for at least one first human object; and
determine said first direction according to said first human object for whom lip motion is detected.

16. A method for enhancing hearing, the method comprising:
detecting, in imaging data provided by a first camera, said first camera mounted on a first side of said hearing-aid device, a direction of orientation of a head of a first user;
detecting, in imaging data provided by a second camera, said second camera mounted on a second side of said hearing-aid device, within said direction of orientation of said head of said first user, a second user talking;
forming an acoustic beam, using a plurality of microphones mounted substantially on said second side of said hearing-aid device, said acoustic beam being directed at said second user;
collecting acoustic signal via said acoustic beam; and
providing said acoustic signal to at least one of a user and an external device.

17. The method for enhancing hearing according to claim 16, wherein said second side is substantially in the opposite side of said first side.

18. The method for enhancing hearing according to claim 16, wherein said imaging data provided by said first camera within said direction of said head of said first user, comprises a sector of a predefined angle around said direction of said head of said first user.

19. The method for enhancing hearing according to claim 16, additionally comprising:
providing a communication interface communicatively coupling said processor to an ear-mounted unit;
communicating said acoustic signal to said ear-mounted unit.

20. The method for enhancing hearing according to claim 19,
detecting head motion of said first user using an accelerometer mounted in said ear-mounted unit used by said first user; and
detecting, in imaging provided by said second camera, a direction of a head of said first user, according to said head motion measurement.

21. A computer program product embodied on a non-transitory computer-readable medium, comprising computer code for:
processing sound source separation on sound input received from providing a plurality of microphones mounted in at least a wide sector to create a plurality of first sound streams, each first sound stream associated with a source of sound;
collecting imaging data from at least one camera mounted to acquire imaging data from at least said wide sector;
detecting in said imaging data at least one image of a first human object;
determining a first direction within said at least wide sector for at least one of said first human objects;
forming an acoustic beam, for at least one of said first directions, using said plurality of microphones, said acoustic beam being directed at said first direction to produce a second sound stream;
comparing said second sound stream with each of said first sound streams to form a plurality of comparison results; and
associating a selected first sound stream with said human object according to a best-fit comparison result.

22. The computer program product according to claim 21, additionally comprising:
communicating a selected first sound stream, via said communication interface, to at least one of a user and an external device.

23. The computer program product according to claim 21, additionally comprising:
acquiring a second imaging data from said at least one camera;
detecting in said second imaging data an image of a head of a second human object;
detecting a direction of orientation of said head of said second human object with respect to said at least wide sector;
determining a selected first human object closest to said direction of orientation of said head of said second human object; and
selecting a first sound stream of said plurality of first sound streams associate with said selected first human object.

24. The computer program product according to claim 23, additionally comprising:
acquiring imaging data from a second camera mounted on a said device pointed in a second direction different than said at least wide sector to collect second imaging data from said second direction.

25. The computer program product according to claim 21, additionally comprising:
detecting lip motion for at least one first human object; and
determining said first direction according to said first human object for whom lip motion is detected.

26. A computer program product for enhancing hearing, the computer program product embodied on a non-transitory computer-readable medium, the computer program product comprising computer code for:
detecting, in imaging data provided by a first camera, said first camera mounted on a first side of said hearing-aid device, a direction of orientation of a head of a first user;
detecting, in imaging data provided by a second camera, said second camera mounted on a second side of said hearing-aid device, within said direction of orientation of said head of said first user, a second user talking;
forming an acoustic beam, using a plurality of microphones mounted substantially on said second side of said hearing-aid device, said acoustic beam being directed at said second user;
collecting acoustic signal via said acoustic beam; and
providing said acoustic signal to at least one of a user and an external device.

27. The computer program product according to claim 26, wherein said second side is substantially in the opposite side of said first side.

28. The computer program product according to claim 26, wherein said imaging data provided by said first camera within said direction of said head of said first user, comprises a sector of a predefined angle around said direction of said head of said first user.

29. The computer program product according to claim 26, additionally comprising:
providing a communication interface communicatively coupling said processor to an ear-mounted unit;
providing said acoustic signal to said ear-mounted unit.

30. The computer program product according to claim 26, additionally comprising:
detecting head motion of said first user using an accelerometer mounted in said ear-mounted unit used by said first user; and
detecting, in imaging provided by said second camera, a direction of a head of said first user, according to said head motion measurement.
